(19) United States
(12) Patent Application Publication
(10) Pub. No.: US 2026/0032518 A1
(43) Pub. Date: Jan. 29, 2026

(54) IN-DEVICE COEXISTENCE INDICATION FOR MULTIPLE BANDWIDTH PARTS IN WIRELESS COMMUNICATION SYSTEM

(71) Applicant: LG ELECTRONICS INC., Seoul (KR)

(72) Inventors: Sunghoon JUNG, Seoul (KR); Myoungsoo KIM, Seoul (KR); Hanseul HONG, Seoul (KR)

(73) Assignee: LG ELECTRONICS INC., Seoul (KR)

(21) Appl. No.: 18/997,786

(22) PCT Filed: Aug. 4, 2023
(86) PCT No.: PCT/KR2023/011493

§ 371 Date: Jan. 22, 2025

Related U.S. Application Data
(60) Provisional application No. 63/394,980, filed on Aug. 4, 2022.

(51) Int. Cl. H04W 28/20; H04B 17/345; H04L 5/00

(52) U.S. Cl. CPC H04W 28/20; H04B 17/345; H04L 5/001

(57) ABSTRACT

The present disclosure relates to in-device coexistence indication for multiple bandwidth parts (BWPs) in wireless communications. According to an embodiment of the present disclosure, a method performed by a user equipment (UE) in a wireless communication system comprises: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

### CROSS-REFERENCE TO RELATED APPLICATION(S)

This application is the National Stage filing under 35 U.S.C. 371 of International Application No. PCT/KR2023/011493, filed on Aug. 4, 2023, which claims the benefit of U.S. Provisional Application No. 63/394,980, filed on Aug. 4, 2022, the contents of which are all incorporated by reference herein in their entirety.

### TECHNICAL FIELD

The present disclosure relates to in-device coexistence indication for multiple bandwidth parts (BWPs) in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

A user equipment (UE) may be equipped with multiple radio transceivers. Due to extreme proximity of multiple radio transceivers within the same UE operating on adjacent frequencies or sub-harmonic frequencies, the interference power coming from a transmitter of the collocated radio may be much higher than the actual received power level of the desired signal for a receiver. This situation causes In-Device Coexistence (IDC) interference and is referred to as IDC problems. When a UE experiences IDC problems that it cannot solve by itself and a network intervention is required, it sends an IDC indication to report the IDC problems to network. For example, the UE may send IDC indication(s) for multiple BWPs.

### SUMMARY

An aspect of the present disclosure is to provide method and apparatus for IDC indication in a wireless communication system.

Another aspect of the present disclosure is to provide method and apparatus for IDC indication for multiple BWPs in a wireless communication system.

According to an embodiment of the present disclosure, a method performed by a user equipment (UE) in a wireless communication system comprises: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), a configuration for a plurality of bandwidth parts (BWPs); transmitting, to the UE, a configuration for a subset of BWPs among the plurality of BWPs; and receiving, from the UE, IDC information comprising an IDC status of a BWP in which IDC status change is detected based on the BWP being included in the subset of BWPs, wherein the UE is further configured to: detect a change of an IDC status in the BWP among the plurality of BWPs; determine whether the BWP in which IDC status change is detected is included in the subset of BWPs; and transmit, to the network, the IDC information comprising the IDC status of the BWP, based on the BWP being included in the subset of BWPs.

According to an embodiment of the present disclosure, a method performed by a network node configured to operate in a wireless communication system comprises: transmitting, to a user equipment (UE), a configuration for a plurality of bandwidth parts (BWPs); transmitting, to the UE, a configuration for a subset of BWPs among the plurality of BWPs; and receiving, from the UE, IDC information comprising an IDC status of a BWP in which IDC status change is detected based on the BWP being included in the subset of BWPs, wherein the UE is further configured to: detect a change of an IDC status in the BWP among the plurality of BWPs; determine whether the BWP in which IDC status change is detected is included in the subset of BWPs; and transmit, to the network, the IDC information comprising the IDC status of the BWP, based on the BWP being included in the subset of BWPs.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

According to an embodiment of the present disclosure, a non-transitory computer readable medium (CRM) has stored thereon a program code implementing instructions that, based on being executed by at least one processor, perform operations comprising: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

The present disclosure may have various advantageous effects.

For example, the UE may indicate to the network IDC statuses of configured BWPs properly while preventing too frequent triggering of IDC indications.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a BWP configuration to which technical features of the present disclosure is applied.

FIG. 9 shows an example of phases of IDC interference situation according to an embodiment of the present disclosure.

FIG. 10 shows an example of an IDC procedure according to an embodiment of the present disclosure.

FIG. 11 shows an example of a method performed by a UE according to an embodiment of the present disclosure.

FIG. 12 shows an example of a signal flow between UE and network node according to an embodiment of the present disclosure.

FIG. 13 shows an example of a signal flow for transmitting IDC indication message based on condition 1 according to an embodiment of the present disclosure.

FIG. 14 shows an example of a signal flow for transmitting IDC indication message based on condition 2 according to an embodiment of the present disclosure.

FIG. 15 shows an example of a signal flow for transmitting IDC indication message based on condition 3 according to an embodiment of the present disclosure.

FIG. 16 shows an example of a signal flow for transmitting IDC indication message based on BWP switching according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

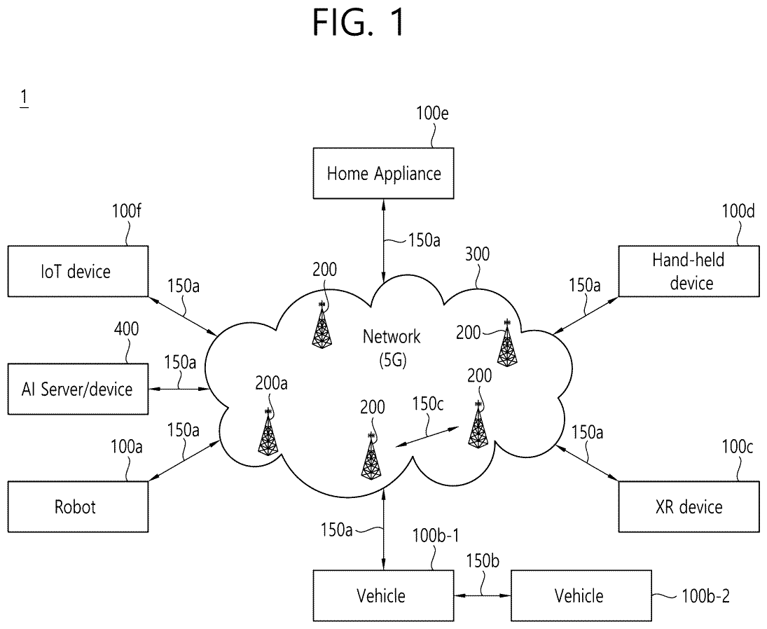

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IOT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc.

The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHZ, etc.) or more. For example, a frequency band of 6 GHz (or 5850, 5900, 5925 MHz, etc.) or more included in FRI may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

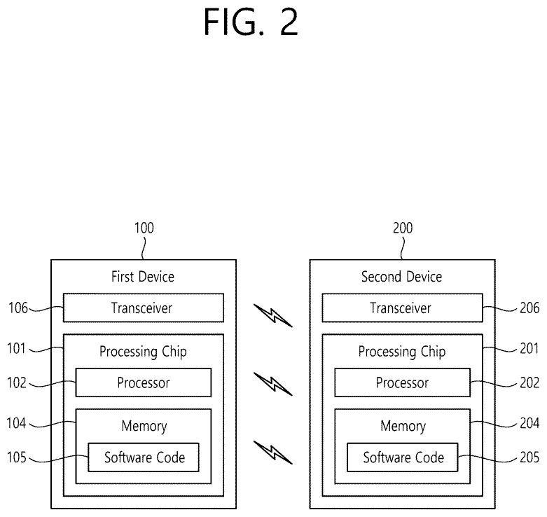

Here, the radio communication technologies implemented in the wireless devices in the present disclosure may include NarrowBand IoT (NB-IOT) technology for low-power communication as well as LTE, NR and 6G. For example, NB-IOT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

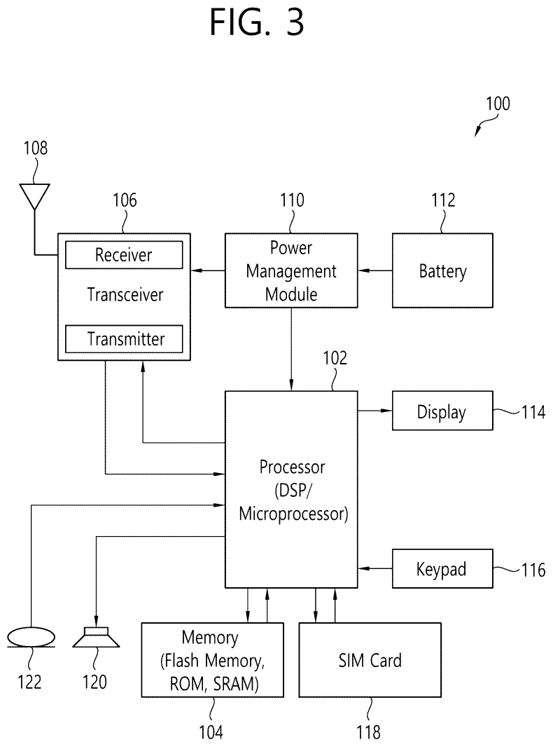

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

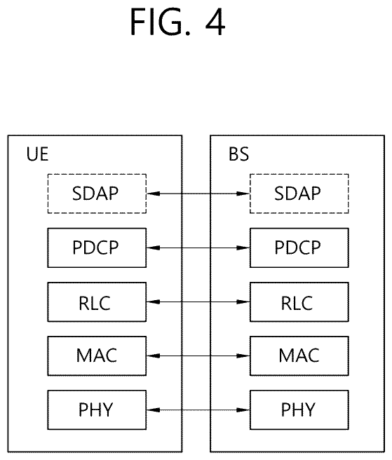

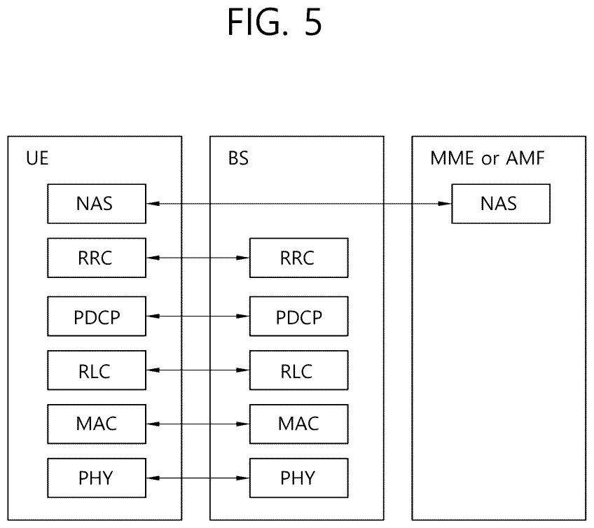

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

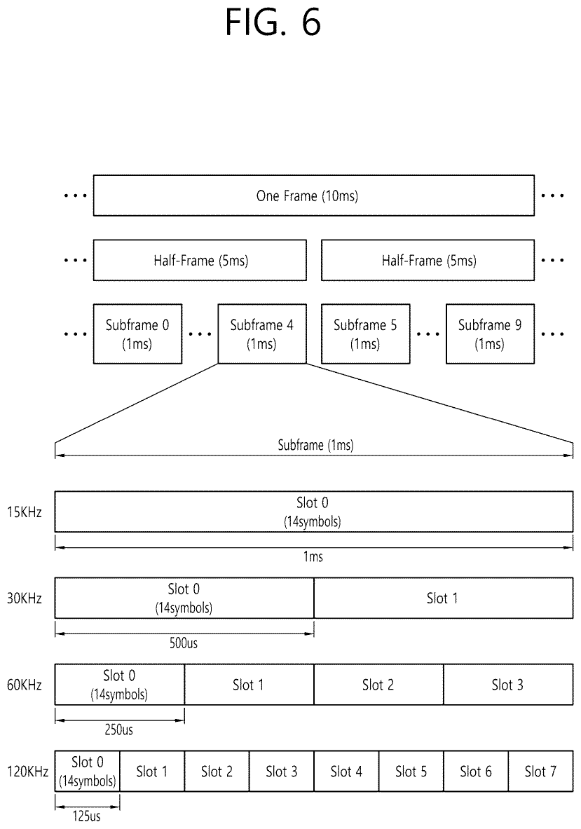

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | NN^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration w. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

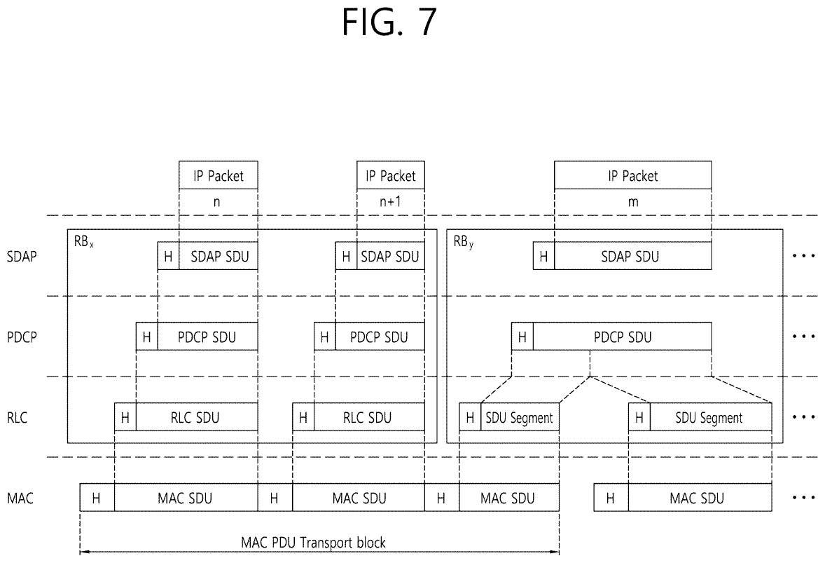

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents regarding a bandwidth part (BWP) is described.

BWP may be a contiguous set of physical resource blocks (PRBs), selected from a contiguous subset of the common resource blocks (CRBs) for a given numerology u on a given carrier.

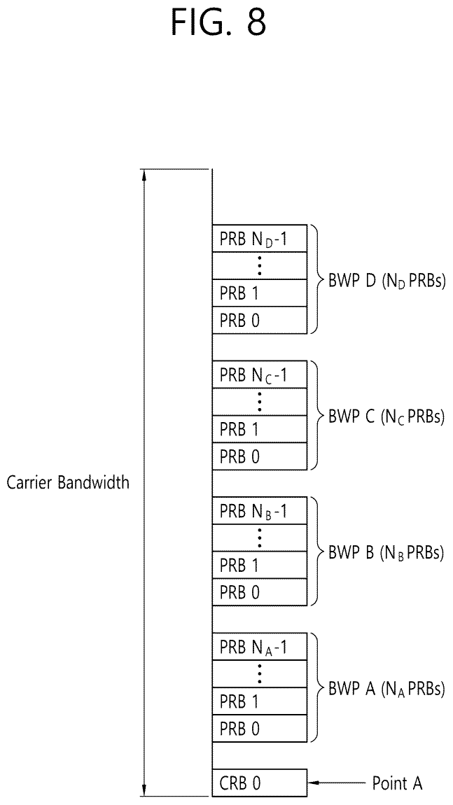

FIG. 8 shows an example of a BWP configuration to which technical features of the present disclosure is applied.

Referring to FIG. 8, 4 BWPs (i.e., BWP A, BWP B, BWP C and BWP D) are configured in a carrier bandwidth. The carrier bandwidth (or, carrier band) may comprise CRBs numbered from CRB0. CRB0 may correspond to or may be determined based on point A. Point A may indicate a common reference point for resource block grids and may be obtained from higher layer parameters.

The BWP A may comprise N_{A} PRBs numbered from PRB0 to PRB N_{A}−1. The PRB0 in the BWP A may have the number of offset PRBs/CRBs with respect to the CRB0, which may or may not be configured from a network.

The BWP B may comprise N_{B} PRBs numbered from PRB0 to PRB N_{B}−1. The PRB0 in the BWP B may have the number of offset PRBs/CRBs with respect to the CRB0, which may or may not configured from a network.

The BWP C may comprise N_{C} PRBs numbered from PRB0 to PRB N_{C}−1. The PRB0 in the BWP C may have the number of offset PRBs/CRBs with respect to the CRB0, which may or may not configured from a network.

The BWP D may comprise N_{D} PRBs numbered from PRB0 to PRB N_{D}−1. The PRB0 in the BWP D may have the number of offset PRBs/CRBs with respect to the CRB0, which may or may not configured from a network.

There may be various types of BWPs, such as initial BWP, first active BWP, default BWPs, and/or regular BWPs.

Initial BWP (determined by initialDwonlinkBWP or initialUplinkBWP) may be used for initial access (e.g., DL synchronization procedure, random access procedure) before RRC connection is established.

First active BWP (determined by firstActiveDownlinkBWP-Id or firstActive UplinkBWP-Id) may be a BWP to be active right after the initial attach is completed.

Default BWP (determined by defaultDownlinkBWP-Id or defaultUplinkBWP-Id) may be a BWP to which UE and/or network automatically switches when there is no activity in current BWP while BWP inactivity timer is running. The BWP inactivity timer may indicate a duration after which the UE falls back to the default BWP.

Regular BWP may be a BWP after or before BWP switching is performed to or from the initial BWP/first active BWP/default BWP.

A UE configured for operation in bandwidth parts (BWPs) of a serving cell, is configured by higher layers for the serving cell a set of at most four bandwidth parts (BWPs) for receptions by the UE (DL BWP set) in a DL bandwidth by parameter BWP-Downlink or by parameter initialDownlinkBWP with a set of parameters configured by BWP-DownlinkCommon and BWP-DownlinkDedicated, and a set of at most four BWPs for transmissions by the UE (UL BWP set) in an UL bandwidth by parameter BWP-Uplink or by parameter initialUplinkBWP with a set of parameters configured by BWP-UplinkCommon and BWP-UplinkDedicated.

If a UE is not provided initialDownlinkBWP, an initial DL BWP is defined by a location and number of contiguous PRBs, starting from a PRB with the lowest index and ending at a PRB with the highest index among PRBs of a CORESET for Type0-PDCCH CSS set, and a SCS and a cyclic prefix for PDCCH reception in the CORESET for Type0-PDCCH CSS set; otherwise, the initial DL BWP is provided by initialDownlinkBWP. For operation on the primary cell or on a secondary cell, a UE is provided an initial UL BWP by initialUplinkBWP. If the UE is configured with a supplementary UL carrier, the UE can be provided an initial UL BWP on the supplementary UL carrier by initialUplinkBWP.

If a UE has dedicated BWP configuration, the UE can be provided by firstActive DownlinkBWP-Id a first active DL BWP for receptions and by firstActiveUplinkBWP-Id a first active UL BWP for transmissions on a carrier of the primary cell.

For a serving cell, a UE can be provided by defaultDownlinkBWP-Id a default DL BWP among the configured DL BWPs. If a UE is not provided a default DL BWP by defaultDownlinkBWP-Id, the default DL BWP is the initial DL BWP.

UE may receive a BWP configuration from a network. The BWP configuration may comprise a plurality of configurations each of which is related to a corresponding BWP.

A configuration for a BWP may comprise at least one of the following parameters for a serving cell:
subcarrierSpacing indicating a subcarrier spacing applied to the BWP;
cyclicPrefix indicating a cyclic prefix applied to symbols on the BWP;
locationAndBandwidth indicating a resource block (RB) offset of the BWP with respect to a lowest RB of a carrier for the subcarrier spacing, and a length of the BWP expressed in the number of contiguous RBs;
BWP-Id indicating an index of the BWP;
BWP-DownlinkCommon BWP-UplinkCommon indicating a set of BWP-common parameters for the BWP; or
BWP-DownlinkDedicated BWP-UplinkDedicated indicating a set of BWP-dedicated parameters for the BWP.

The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signalling, or by the MAC entity itself upon initiation of Random Access procedure or upon detection of consistent LBT failure on SpCell.

Upon initiation of the Random Access procedure on a Serving Cell, after the selection of carrier for performing Random Access procedure, the MAC entity shall for the selected carrier of this Serving Cell:
1> if PRACH occasions are not configured for the active UL BWP:
2> if the UE is a RedCap UE; and
2> if initialUplinkBWP-RedCap is configured:
3> switch the active UL BWP to BWP configured by initialUplinkBWP-RedCap.
2> else:
3> switch the active UL BWP to BWP indicated by initialUplinkBWP.
2> if the Serving Cell is an SpCell:
3> if the UE is a RedCap UE; and
3> if initialDownlinkBWP-RedCap is configured:
4> switch the active DL BWP to BWP configured by initialDownlinkBWP-RedCap.
3> else:
4> switch the active DL BWP to BWP indicated by initialDownlinkBWP.
1> else:
2> if the Serving Cell is an SpCell:
3> if the active DL BWP does not have the same bwp-Id as the active UL BWP:
4> switch the active DL BWP to the DL BWP with the same bwp-Id as the active UL BWP.

1> stop the bwp-InactivityTimer associated with the active DL BWP of this Serving Cell, if running.
1> if the Serving Cell is SCell:
2> stop the bwp-Inactivity Timer associated with the active DL BWP of SpCell, if running.
1> perform the Random Access procedure on the active DL BWP of SpCell and active UL BWP of this Serving Cell.

Upon RRC (re-)configuration of firstActive DownlinkBWP-Id and/or firstActive UplinkBWP-Id for SpCell except for PSCell when SCG is deactivated or activation of an SCell, the DL BWP and/or UL BWP indicated by firstActiveDownlinkBWP-Id and/or firstActive UplinkBWP-Id respectively is active without receiving PDCCH indicating a downlink assignment or an uplink grant. Upon RRC (re-)configuration of firstActiveDownlinkBWP-Id for PSCell when SCG is deactivated, the DL BWP is switched to the firstActiveDownlinkBWP-Id. The active BWP for a Serving Cell is indicated by either RRC or PDCCH. For unpaired spectrum, a DL BWP is paired with a UL BWP, and BWP switching is common for both UL and DL.

If the MAC entity receives a PDCCH for BWP switching of a Serving Cell, the MAC entity shall:
1> if there is no ongoing Random Access procedure associated with this Serving Cell; or
1> if the ongoing Random Access procedure associated with this Serving Cell is successfully completed upon reception of this PDCCH addressed to C-RNTI:
2> cancel, if any, triggered consistent LBT failure for this Serving Cell;
2> perform BWP switching to a BWP indicated by the PDCCH.

If the MAC entity receives a PDCCH for BWP switching for a Serving Cell(s) or a dormancy SCell group(s) while a Random Access procedure associated with that Serving Cell is ongoing in the MAC entity, it is up to UE implementation whether to switch BWP or ignore the PDCCH for BWP switching, except for the PDCCH reception for BWP switching addressed to the C-RNTI for successful Random Access procedure completion in which case the UE shall perform BWP switching to a BWP indicated by the PDCCH. Upon reception of the PDCCH for BWP switching other than successful contention resolution, if the MAC entity decides to perform BWP switching, the MAC entity shall stop the ongoing Random Access procedure and initiate a Random Access procedure after performing the BWP switching; if the MAC decides to ignore the PDCCH for BWP switching, the MAC entity shall continue with the ongoing Random Access procedure on the Serving Cell.

Upon reception of RRC (re-)configuration for BWP switching for a Serving Cell while a Random Access procedure associated with that Serving Cell is ongoing in the MAC entity, the MAC entity shall stop the ongoing Random Access procedure and initiate a Random Access procedure after performing the BWP switching.

The MAC entity shall for each activated Serving Cell configured with bwp-Inactivity Timer:
1> if the defaultDownlinkBWP-Id is configured, and the active DL BWP is not the BWP indicated by the defaultDownlinkBWP-Id, and the active DL BWP is not the BWP indicated by the dormantBWP-Id if configured; or
1> if the defaultDownlinkBWP-Id is not configured, and if the UE is not a RedCap UE, and the active DL BWP is not the initialDownlinkBWP, and the active DL BWP is not the BWP indicated by the dormantBWP-Id if configured; or
1> if the defaultDownlinkBWP-Id is not configured and if the UE is a RedCap UE, and initialDownlinkBWP-RedCap is not configured, and the active DL BWP is not the initialDownlinkBWP, and the active DL BWP is not the BWP indicated by the dormantBWP-Id if configured; or
1> if the defaultDownlinkBWP-Id is not configured and if the UE is a RedCap UE, and initialDownlinkBWP-RedCap is configured, the active DL BWP is not the initialDownlinkBWP-RedCap, and the active DL BWP is not the BWP indicated by the dormantBWP-Id if configured:
2> if a PDCCH addressed to C-RNTI or CS-RNTI indicating downlink assignment or uplink grant is received on the active BWP; or
2> if a PDCCH addressed to G-RNTI or G-CS-RNTI configured for multicast indicating downlink assignment is received on the active BWP; or
2> if a PDCCH addressed to C-RNTI or CS-RNTI indicating downlink assignment or uplink grant is received for the active BWP; or
2> if a MAC PDU is transmitted in a configured uplink grant and LBT failure indication is not received from lower layers; or
2> if a MAC PDU is received in a configured downlink assignment for unicast or MBS multicast:
3> if there is no ongoing Random Access procedure associated with this Serving Cell; or
3> if the ongoing Random Access procedure associated with this Serving Cell is successfully completed upon reception of this PDCCH addressed to C-RNTI:
4> start or restart the bwp-InactivityTimer associated with the active DL BWP.
2> if the bwp-InactivityTimer associated with the active DL BWP expires:
3> if the defaultDownlinkBWP-Id is configured:
4> perform BWP switching to a BWP indicated by the defaultDownlinkBWP-Id.
3> else:
4> if the UE is a RedCap UE; and
4> if initialDownlinkBWP-RedCap is configured:
5> perform BWP switching to the initialDownlinkBWP-RedCap.
4> else:
5> perform BWP switching to the initialDownlinkBWP.

If a Random Access procedure is initiated on an SCell, both this SCell and the SpCell are associated with this Random Access procedure.
1> if a PDCCH for BWP switching is received, and the MAC entity switches the active DL BWP:
2> if the defaultDownlinkBWP-Id is configured, and the MAC entity switches to the DL BWP which is not indicated by the defaultDownlinkBWP-Id and is not indicated by the dormantBWP-Id if configured; or
2> if the defaultDownlinkBWP-Id is not configured, and the MAC entity switches to the DL BWP which is not the initialDownlinkBWP and is not indicated by the dormantBWP-Id if configured:
3> start or restart the bwp-InactivityTimer associated with the active DL BWP.

For each activated Serving Cell configured with a BWP, the MAC entity shall:
1> if a BWP is activated and the active DL BWP for the Serving Cell is not the dormant BWP:
2> transmit on UL-SCH on the BWP;
2> transmit on RACH on the BWP, if PRACH occasions are configured;
2> monitor the PDCCH on the BWP;
2> transmit PUCCH on the BWP, if configured;
2> report CSI for the BWP;
2> transmit SRS on the BWP, if configured;
2> receive DL-SCH on the BWP;
2> (re-) initialize any suspended configured uplink grants of configured grant Type 1 on the active BWP according to the stored configuration, if any, and to start in the symbol;
1> if a BWP is deactivated:
2> not transmit on UL-SCH on the BWP;
2> not transmit on RACH on the BWP;
2> not monitor the PDCCH on the BWP;
2> not transmit PUCCH on the BWP;
2> not report CSI for the BWP;
2> not transmit SRS on the BWP;
2> not receive DL-SCH on the BWP;
2> clear any configured downlink assignment and configured uplink grant of configured grant Type 2 on the BWP;
2> suspend any configured uplink grant of configured grant Type 1 on the inactive BWP. Hereinafter, contents regarding in-device coexistence (IDC) are described.

In order to allow users to access various networks and services ubiquitously, an increasing number of UEs are equipped with multiple radio transceivers. For example, a UE may be equipped with LTE, NR, WiFi, and Bluetooth transceivers, and GNSS receivers. Due to extreme proximity of multiple radio transceivers within the same UE operating on adjacent frequencies or sub-harmonic frequencies, the interference power coming from a transmitter of the collocated radio may be much higher than the actual received power level of the desired signal for a receiver. This situation causes In-Device Coexistence (IDC) interference and is referred to as IDC problems. The challenge lies in avoiding or minimizing IDC interference between those collocated radio transceivers, as current state-of-the-art filter technology might not provide sufficient rejection for certain scenarios. IDC problem can happen when the UE (intends to) uses WLAN on the overlapped carrier/band or adjacent carrier/band to the unlicensed carrier used for LAA operation, e.g. when related UE hardware components, such as antennas, are shared between LAA and WLAN operations. If there is a risk of IDC problem which cannot be avoided (e.g. by level of regulation), the IDC functionality for a UE should be configured by the network when the UE is configured for LAA operation.

When a UE experiences IDC problems that it cannot solve by itself and a network intervention is required, it sends an IDC indication via dedicated RRC signalling to report the IDC problems to the network. The UE may rely on existing measurements and/or UE internal coordination to assess the interference and the details are left up to UE implementation.

For instance, the interference is applicable over several subframes/slots where not necessarily all the subframes/slots are affected and consists of interference caused by the aggressor radio to the victim radio during either active data exchange or upcoming data activity which is expected in up to a few hundred milliseconds.

A UE that supports IDC functionality indicates related capabilities to the network, and the network can then configure by dedicated signalling whether the UE is allowed to send an IDC indication. The IDC indication can only be triggered for frequencies for which a measurement object is configured and when:
for the primary frequency, the UE is experiencing IDC problems that it cannot solve by itself;
for a secondary frequency, regardless of the activation state of the corresponding SCell, the UE is experiencing or expects to experience upon activation IDC problems that it cannot solve by itself;
for a non-serving frequency, the UE expects to experience IDC problems that it cannot solve by itself if that non-serving frequency becomes a serving one.

When notified of IDC problems through an IDC indication from the UE, the network can choose to apply a Frequency Division Multiplexing (FDM) solution or a Time Division Multiplexing (TDM) solution:
The basic concept of an FDM solution is to move the signal away from the ISM band by e.g., performing inter-frequency handover within eNB/gNB, removing SCells from the set of serving cells or de-activation of affected SCells, or in case of uplink CA operations, allocate uplink PRB resources on CC(s) whose inter-modulation distortion and harmonics does not fall into the frequency range of the victim system receiver.
The basic concept of a TDM solution is to ensure that transmission of a radio signal does not coincide with reception of another radio signal. DRX mechanism is used to provide TDM patterns (i.e. periods during which the UE may be scheduled or is not scheduled) to resolve the IDC issues. DRX based TDM solution should be used in a predictable way, i.e. the network should ensure a predictable pattern of unscheduled periods by means of e.g. DRX mechanism or de-activation of affected SCells.

To assist the network in selecting an appropriate solution, all necessary/available assistance information for both FDM and TDM solutions is sent together in the IDC indication to the network. The IDC assistance information contains the list of E-UTRA carriers suffering from IDC problems, the direction of the interference and, depending on the scenario, it also contains TDM patterns or parameters to enable appropriate DRX configuration for TDM solutions on the serving E-UTRA carrier. Furthermore, the IDC indication can also be configured to include uplink CA related assistance information containing the victim system as well as the list of supported uplink CA combinations suffering from IDC problems. Furthermore, the IDC indication can also be configured to indicate that the cause of IDC problems is hardware sharing between LAA and WLAN operation, in which case the UE may omit the TDM assistance information. The IDC indication is also used to update the IDC assistance information, including for the cases when the UE no longer suffers from IDC problems. In case of inter-base station (e.g., eNB/gNB) handover, the IDC assistance information is transferred from the source base station to the target base station.

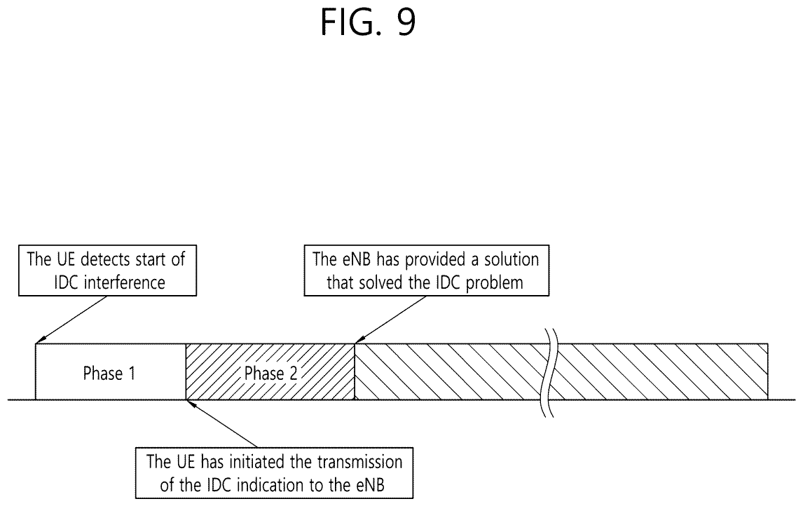

FIG. 9 shows an example of phases of IDC interference situation according to an embodiment of the present disclosure.

Referring to FIG. 9, in phase 1, the UE detects start of IDC interference but does not initiate the transmission of the IDC indication to the network yet.

In phase 2, the UE has initiated the transmission of the IDC indication to the network and no solution is yet configured by the network to solve the IDC issue.

In phase 3, the network has provided a solution that solved the IDC interference to the UE.

In different phases, UE behaviours related to RRM, RLM, and CSI measurements are shown in Table 5:

TABLE 5

| Phases of | RRM | RLM | CSI |
|---|---|---|---|
| IDC Interference | Measurements | Measurements | Measurements |
| Phase 1 | Up to UE | Up to UE | Up to UE |
| | implementation and | implementation and | implementation and |
| | RRM measurement | RLM measurement | CSI measurement |
| | requirements apply | requirements apply | requirements apply |
| Phase 2 | UE shall ensure the | UE shall ensure the | When experiencing |
| | measurements are | measurements are | IDC problem caused |
| | free of IDC | free of IDC | by the hardware |
| | interference and | interference and | sharing between LAA |
| | RRM measurement | RLM measurement | and WLAN the UE |
| | requirements apply. | requirements apply. | shall be allowed to |
| | | | relax the existing |
| | | | RRM/CSI |
| | | | measurement |
| | | | requirement during |
| | | | phase 2. |
| Phase 3 | UE shall ensure the | UE shall ensure the | |
| | measurements are | measurements are | |
| | free of IDC | free of IDC | |
| | interference and | interference and | |
| | RRM measurement | RLM measurement | |
| | requirements apply | requirements apply | |

The UE should attempt to maintain connectivity to radio access technology (RAT) (e.g., LTE/NR) in this phase meaning that RLM measurements are not impacted by IDC interference. If no solution is provided within a time which is up to UE implementation, the UE may need to declare RLF or it may continue to deny the ISM transmission. In DC, when the UE experiences IDC problems in SCG, if no solution is provided within a time which is up to UE implementation, the UE may need to declare RLF in SCG or it may continue to deny the ISM transmission in SCG. If the UE determines in Phase 2 that the network does not provide a solution that resolves its IDC problems, it performs measurements as defined for Phase 1.

If the IDC indication message reports the IDC interference on a neighbour frequency, it performs RRM measurements for that frequency as defined for Phase 2.

When experiencing IDC problem caused by the hardware sharing between LAA and WLAN the UE shall be allowed to relax the existing RRM/CSI measurement requirement during phase 2.

In addition, once configured by the network, the UE can autonomously deny UL transmission in all phases to protect ISM in rare cases if other solutions cannot be used. Conversely, it is assumed that the UE also autonomously denies ISM transmission in order to ensure connectivity with the network to perform necessary procedures, e.g., RRC connection reconfiguration and paging reception, etc. The network may configure a long-term denial rate by dedicated RRC signalling to limit the amount of UL autonomous denials. Otherwise, the UE shall not perform any UL autonomous denials.

Hereinafter, IDC indication procedure is described.

The purpose of the IDC indication procedure is to inform network about (a change of) the In-Device Coexistence (IDC) problems experienced by the UE in RRC_CONNECTED, and to provide the network with information in order to resolve them.

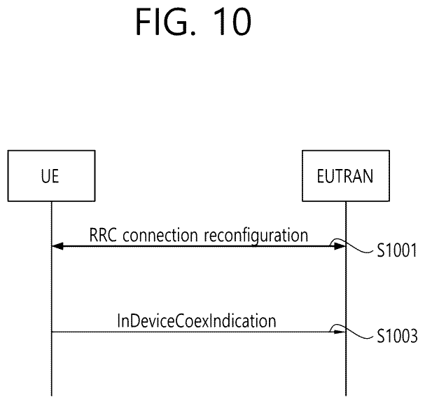

FIG. 10 shows an example of an IDC procedure according to an embodiment of the present disclosure.

Referring to FIG. 10, in step S1001, UE may receive an RRC reconfiguration from a network. The RRC reconfiguration may comprise an IDC configuration (i.e., IDC-Config). The IDC configuration may comprise the following information elements (IEs) as shown in table 6:

TABLE 6

| | |
|---|---|
| IDC-Config-r11 ::= | SEQUENCE { |

idc-Indication-r11

| | |
|---|---|
| ENUMERATED {setup} | OPTIONAL, -- Need |

OR

| | |
|---|---|
| autonomousDenialParameters-r11 | SEQUENCE { |

autonomousDenialSubframes-r11

ENUMERATED {n2, n5, n10, n15,

```
  n20, n30, spare2, spare1},
  autonomousDenialValidity-r11
```

ENUMERATED {

| | sf200, sf500, sf1000, sf2000, | |
|---|---|---|
| | spare4, spare3, spare2, spare1} | |
| } | OPTIONAL, | -- Need OR |

| ..., | |
|---|---|
| [[ | idc-Indication-UL-CA-r11 |

| | | |
|---|---|---|
| ENUMERATED {setup} | OPTIONAL | -- Cond idc-Ind |

| | ]], | | |
|---|---|---|---|
| | [[ | idc-HardwareSharingIndication-r13 | ENUMERATED |
| {setup} | OPTIONAL | -- Need OR | |
| | ]], | | |
| | [[ | idc-Indication-MRDC-r15 | CHOICE{ |

| | |
|---|---|
| release | NULL, |

setup

CandidateServingFreqListNR-r15

| | | |
|---|---|---|
| } | OPTIONAL | -- Cond idc-Ind |

]]

}

In table 6:—idc-Indication is used to indicate whether the UE is configured to initiate transmission of the InDeviceCoexIndication message to the network.
idc-Indication-MRDC is used to indicate whether the UE is configured to provide IDC indications for MR-DC using the InDeviceCoexIndication message.
idc-Indication-UL-CA is used to indicate whether the UE is configured to provide IDC indications for UL CA using the InDeviceCoexIndication message.
idc-HardwareSharingIndication is used to indicate whether the UE is allowed indicate in InDeviceCoexIndication that the cause of the problems are due to hardware sharing, and whether the UE is allowed to omit the TDM assistance information.
autonomousDenialSubframes indicates the maximum number of the UL subframes for which the UE is allowed to deny any UL transmission. Value n2 corresponds to 2 subframes, n5 to 5 subframes and so on. Network does not configure autonomous denial for frequencies on which SCG cells are configured.
autonomousDenialValidity indicates the validity period over which the UL autonomous denial subframes shall be counted. Value sf200 corresponds to 200 subframes, sf500 corresponds to 500 subframes and so on.

The UE shall:
1> if the received RRC reconfiguration includes the idc-Config:
2> if idc-Indication is included (i.e. set to setup):
3> consider itself to be configured to provide IDC indications;
3> if idc-Indication-UL-CA is included (i.e. set to setup):
4> consider itself to be configured to indicate UL CA related information in IDC indications;
3> if idc-HardwareSharingIndication is included (i.e. set to setup):
4> consider itself to be configured to indicate IDC hardware sharing problem indications in IDC indications;
3> if idc-Indication-MRDC is included (i.e. set to setup):
4> consider itself to be configured to provide IDC indications for MR-DC;
2> else:
3> consider itself not to be configured to provide IDC indications;
2> if autonomousDenialParameters is included:
3> consider itself to be allowed to deny any transmission in a particular UL subframe if during the number of subframes indicated by autonomousDenialValidity, preceeding and including this particular subframe, it autonomously denied fewer UL subframes than indicated by autonomousDenialSubframes;
2> else:
3> consider itself not to be allowed to deny any UL transmission;
In step S1003, the UE may transmit IDC indication message (i.e., InDeviceCoexIndication message) to the network, based on the IDC configuration.

A UE capable of providing IDC indications (e.g., InDeviceCoexIndication message) may initiate a transmission of the IDC indication when it is configured to provide IDC indications and upon change of IDC problem information.

Upon initiating a transmission of the IDC indication, the UE shall:
1> if configured to provide IDC indications:
2> if the UE did not transmit an InDeviceCoexIndication message since it was configured to provide IDC indications:
3> if on one or more frequencies for which a measObjectEUTRA is configured, the UE is experiencing IDC problems that it cannot solve by itself; or
3> if configured to provide IDC indications for UL CA; and if on one or more supported UL CA combination comprising of carrier frequencies for which a measurement object is configured, the UE is experiencing IDC problems that it cannot solve by itself:
4> initiate transmission of the InDeviceCoexIndication message;
2> else:
3> if the set of frequencies, for which a measObjectEUTRA is configured and on which the UE is experiencing IDC problems that it cannot solve by itself, is different from the set indicated in the last transmitted InDeviceCoexIndication message; or
3> if for one or more of the frequencies in the previously reported set of frequencies, the interferenceDirection is different from the value indicated in the last transmitted InDeviceCoexIndication message; or
3> if the TDM assistance information is different from the assistance information included in the last transmitted InDeviceCoexIndication message; or
3> if configured to provide IDC indications for UL CA; and if the victimSystem Type is different from the value indicated in the last transmitted InDeviceCoexIndication message; or
3> if configured to provide IDC indications for UL CA; and if the set of supported UL CA combinations on which the UE is experiencing IDC problems that it cannot solve by itself and that the UE includes in affectedCarrierFreqCombList is different from the set indicated in the last transmitted InDeviceCoexIndication message:
4> initiate transmission of the InDeviceCoexIndication message;

The term “IDC problems” refers to interference issues applicable across several subframes/slots where not necessarily all the subframes/slots are affected.

For the frequencies on which a serving cell or serving cells is configured that is activated, IDC problems consist of interference issues that the UE cannot solve by itself, during either active data exchange or upcoming data activity which is expected in up to a few hundred milliseconds.

For frequencies on which a SCell or SCells is configured that is deactivated, reporting IDC problems indicates an anticipation that the activation of the SCell or SCells would result in interference issues that the UE would not be able to solve by itself.

For a non-serving frequency, reporting IDC problems indicates an anticipation that if the non-serving frequency or frequencies became a serving frequency or serving frequencies then this would result in interference issues that the UE would not be able to solve by itself.

The UE shall set the contents of the InDeviceCoexIndication message as follows:
1> if there is at least one E-UTRA carrier frequency, for which a measurement object is configured, that is affected by IDC problems:
2> include the field affectedCarrierFreqList with an entry for each affected E-UTRA carrier frequency for which a measurement object is configured;
2> for each E-UTRA carrier frequency included in the field affectedCarrierFreqList, include interference Direction and set it accordingly;
2> include Time Domain Multiplexing (TDM) based assistance information, unless idc-HardwareSharingIndication is configured and the UE has no Time Doman Multiplexing based assistance information that could be used to resolve the IDC problems:
3> if the UE has DRX related assistance information that could be used to resolve the IDC problems:
4> include drx-CycleLength, drx-Offset and drx-Active Time;
3> else (the UE has desired subframe reservation patterns related assistance information that could be used to resolve the IDC problems):
4> include idc-SubframePatternList;
3> use the MCG as timing reference if TDM based assistance information regarding the SCG is included;
1> if the UE is configured to provide UL CA information and there is a supported UL CA combination comprising of carrier frequencies for which a measurement object is configured, that is affected by IDC problems:
2> include victimSystem Type in ul-CA-AssistanceInfo;
2> if the UE sets victimSystem Type to wlan or Bluetooth:
3> include affectedCarrierFreqCombList in ul-CA-AssistanceInfo with an entry for each supported UL CA combination comprising of carrier frequencies for which a measurement object is configured, that is affected by IDC problems;
2> else:
3> optionally include affectedCarrierFreqCombList in ul-CA-AssistanceInfo with an entry for each supported UL CA combination comprising of carrier frequencies for which a measurement object is configured, that is affected by IDC problems;
1> if idc-HardwareSharingIndication is configured, and there is at least one E-UTRA carrier frequency, for which a measurement object is configured, the UE is experiencing hardware sharing problems that it cannot solve by itself:
2> include the hardwareSharingProblem and set it accordingly;
When sending an InDeviceCoexIndication message to inform network the IDC problems, the UE includes all assistance information (rather than providing e.g. the changed part(s) of the assistance information).

Upon not anymore experiencing a particular IDC problem that the UE previously reported, the UE provides an IDC indication with the modified contents of the InDeviceCoexIndication message (e.g. by an empty message).

The UE shall submit the InDeviceCoexIndication message to lower layers for transmission.

As described above, the InDeviceCoexIndication message is used to inform network about IDC problems which cannot be solved by the UE itself, as well as to provide information that may assist network when resolving these problems.

Characteristics of the InDeviceCoexIndication message is described below:
Signalling radio bearer: SRB1
RLC-SAP: AM
Logical channel: DCCH
Direction: UE to Network

Information elements (IEs) in the InDeviceCoexIndication message are described in table 6:

TABLE 7

| InDeviceCoexIndication-r11 ::= | | SEQUENCE { |
|---|---|---|
| | criticalExtensions | CHOICE { |

c1

CHOICE {

inDeviceCoexIndication-r11

InDeviceCoexIndication-r11-IEs,

| spare3 NULL, spare2 NULL, spare1 NULL | |
|---|---|
| }, | |
| criticalExtensionsFuture | SEQUENCE { } |

}

}

| InDeviceCoexIndication-r11-IEs ::= | | SEQUENCE { |
|---|---|---|
| | affectedCarrierFreqList-r11 | |
| AffectedCarrierFreqList-r11 | | OPTIONAL, |
| | tdm-AssistanceInfo-r11 | TDM-AssistanceInfo- |
| r11 | | OPTIONAL, |
| | lateNonCriticalExtension | OCTET STRING |

OPTIONAL,

nonCriticalExtension

| | |
|---|---|
| InDeviceCoexIndication-v11d0-IEs | OPTIONAL |

}

| InDeviceCoexIndication-v11d0-IEs ::= | | SEQUENCE { |
|---|---|---|
| | ul-CA-AssistanceInfo-r11 | SEQUENCE { |

affectedCarrierFreqCombList-r11

| | |
|---|---|
| AffectedCarrierFreqCombList-r11 | OPTIONAL, |

victimSystemType-r11

VictimSystemType-r11

}

OPTIONAL,

nonCriticalExtension

InDeviceCoexIndication-v1310-IEs

OPTIONAL

}

| InDeviceCoexIndication-v1310-IEs ::= | | SEQUENCE { |
|---|---|---|
| | affectedCarrierFreqList-v1310 | AffectedCarrierFreqList-v1310 |
| | OPTIONAL, | |
| | affectedCarrierFreqCombList-r13 | AffectedCarrierFreqCombList- |

| | |
|---|---|
| r13 | OPTIONAL, |
| | nonCriticalExtension |

InDeviceCoexIndication-v1360-IEs

OPTIONAL

}

| InDeviceCoexIndication-v1360-IEs ::= | | SEQUENCE { |
|---|---|---|
| | hardwareSharingProblem-r13 | ENUMERATED {true} |
| | OPTIONAL, | |
| | nonCriticalExtension | SEQUENCE { } |

OPTIONAL

}

| | |
|---|---|
| AffectedCarrierFreqList-r11 ::= | SEQUENCE (SIZE (1..maxFreqIDC-r11)) OF |

AffectedCarrierFreq-r11
AffectedCarrierFreqList-v1310 ::= SEQUENCE (SIZE (1..maxFreqIDC-r11)) OF
AffectedCarrierFreq-v1310

| AffectedCarrierFreq-r11 ::= | SEQUENCE { | |
|---|---|---|
| | carrierFreq-r11 | MeasObjectId, |
| | interferenceDirection-r11 | ENUMERATED {eutra, other, both, |

spare}
}

| AffectedCarrierFreq-v1310 ::= | SEQUENCE { | |
|---|---|---|
| | carrierFreq-v1310 | MeasObjectId-v1310 |

OPTIONAL

}

| | |
|---|---|
| AffectedCarrierFreqCombList-r11 ::= | SEQUENCE (SIZE (1..maxCombIDC- |

r11)) OF AffectedCarrierFreqComb-r11
AffectedCarrierFreqCombList-r13 ::= SEQUENCE (SIZE (1..maxCombIDC-r11))
OF AffectedCarrierFreqComb-r13

| | |
|---|---|
| AffectedCarrierFreqComb-r11 ::= | SEQUENCE (SIZE (2..maxServCell- |

r10)) OF MeasObjectId
AffectedCarrierFreqComb-r13 ::= SEQUENCE (SIZE (2..maxServCell-r13)) OF
MeasObjectId-r13

| TDM-AssistanceInfo-r11 ::= | CHOICE { | |
|---|---|---|
| | drx-AssistanceInfo-r11 | SEQUENCE { |

drx-CycleLength-r11

ENUMERATED {sf40, sf64, sf80, sf128, sf160,

| | |
|---|---|
| | sf256, spare2, spare1}, |
| | drx-Offset-r11 |
| INTEGER (0..255) | OPTIONAL, |
| | drx-ActiveTime-r11 |

ENUMERATED {sf20, sf30, sf40, sf60, sf80,

| sf100, spare2, spare1} | |
|---|---|
| }, | |
| idc-SubframePatternList-r11 | IDC- |

SubframePatternList-r11,

...

}

| | |
|---|---|
| IDC-SubframePatternList-r11 ::= | SEQUENCE (SIZE |

(1..maxSubframePatternIDC-r11)) OF IDC-SubframePattern-r11
IDC-SubframePattern-r11 ::= CHOICE {

| | |
|---|---|
| subframePatternFDD-r11 | BIT STRING |

(SIZE (4)),

| | |
|---|---|
| subframePatternTDD-r11 | CHOICE { |
| subframeConfig0-r11 | BIT |

STRING (SIZE (70)),

| | |
|---|---|
| subframeConfig1-5-r11 | BIT STRING |

(SIZE (10)),

| | |
|---|---|
| subframeConfig6-r11 | BIT |

STRING (SIZE (60))

},
...

```
  }
  VictimSystemType-r11 ::= SEQUENCE {
```

gps-r11

| | |
|---|---|
| ENUMERATED {true} | OPTIONAL, |

glonass-r11

| | |
|---|---|
| ENUMERATED {true} | OPTIONAL, |

bds-r11

| | |
|---|---|
| ENUMERATED {true} | OPTIONAL, |

galileo-r11

| | |
|---|---|
| ENUMERATED {true} | OPTIONAL, |

wlan-r11

| | |
|---|---|
| ENUMERATED {true} | OPTIONAL, |

bluetooth-r11

| | |
|---|---|
| ENUMERATED {true} | OPTIONAL |

}

In the InDeviceCoexIndication message:-affectedCarrierFreqCombList indicates a list of E-UTRA carrier frequencies that are affected by IDC problems due to Inter-Modulation Distortion and harmonics from E-UTRA when configured with UL CA. affectedCarrierFreqCombList-r13 is used when more than 5 serving cells are configured or affected combinations contain MeasObjectId larger than 32. If affectedCarrierFreqCombList-r13 is included, affectedCarrierFreqCombList-r11 shall not be included;
affectedCarrierFreqList indicates a list of E-UTRA carrier frequencies affected by IDC problems. If network includes affectedCarrierFreqList-v1310 it includes the same number of entries, and listed in the same order, as in affectedCarrierFreqList-r11;
drx-Active Time indicates the desired active time that the network is recommended to configure. Value in number of subframes. Value sf20 corresponds to 20 subframes, sf30 corresponds to 30 subframes and so on.
drx-CycleLength indicates the desired DRX cycle length that the network is recommended to configure. Value in number of subframes. Value sf40 corresponds to 40 subframes, sf64 corresponds to 64 subframes and so on.
drx-Offset indicates the desired DRX starting offset that the network is recommended to configure. The UE shall set the value of drx-Offset smaller than the value of drx-CycleLength. The starting frame and subframe satisfy the relation: [(SFN*10)+subframe number] modulo (drx-CycleLength)=drx-Offset.
hardwareSharingProblem indicates whether the UE has hardware sharing problems that the UE cannot solve by itself. The field is present (i.e. value true), if the UE has such hardware sharing problems. Otherwise the field is absent.
idc-SubframePatternList indicates a list of one or more subframe patterns indicating which HARQ process network is requested to abstain from using. Value 0 indicates that network is requested to abstain from using the subframe. For FDD, the radio frame in which the pattern starts (i.e. the radio frame in which the first/leftmost bit of the subframePatternFDD corresponds to subframe #0) occurs when SFN mod 2=0. For TDD, the first/leftmost bit corresponds to the subframe #0 of the radio frame satisfying SFN mod x=0, where x is the size of the bit string divided by 10. The UE shall indicate a subframe pattern that follows HARQ time line, i.e., if a subframe is set to 1 in the subframe pattern, also the corresponding subframes carrying the potential UL grant, the UL HARQ retransmission and the DL/UL HARQ feedback shall be set to 1.
interferenceDirection indicates the direction of IDC interference. Value eutra indicates that only E-UTRA is victim of IDC interference, value other indicates that only another radio is victim of IDC interference and value both indicates that both E-UTRA and another radio are victims of IDC interference. The other radio refers to either the ISM radio or GNSS.
victimSystem Type indicates the list of victim system types to which IDC interference is caused from E-UTRA when configured with UL CA. Value gps, glonass, bds and galileo indicates the type of GNSS. Value wlan indicates WLAN and value bluetooth indicates Bluetooth.

Meanwhile, in LTE FDM IDC solution, UE detects a IDC status for each frequency and reports IDC assistance information with frequency granularity. In NR, UE can operate in a fraction of cell bandwidth, called BWP. UE can be configured with multiple BWPs, and UE may communicate with its serving cell via one of the configured BWPs, called active BWP. For NR IDC solution, if UE indicates IDC status only for active BWP, network cannot know IDC status for non-active BWPs. This would result in BWP switching to other BWP that would suffer IDC problem, and as a result, the UE would suffer the IDC problem on the new BWP.

Indication of IDC status of non-active BWP may result in too frequent triggering of IDC indications, because change of the individual IDC status of any non-active BWP among configured BWP may trigger IDC indication reporting. This would increase control signalling overhead and unnecessary bandwidth part related reconfigurations.

To solve this problem, the present disclosure proposes a subset of BWPs. UE may transmit IDC information when a BWP for which a change of an IDC status is detected is included in the subset of BWPs, and may not transmit IDC information when a BWP for which a change of an IDC status is detected is not included in the subset of BWPs.

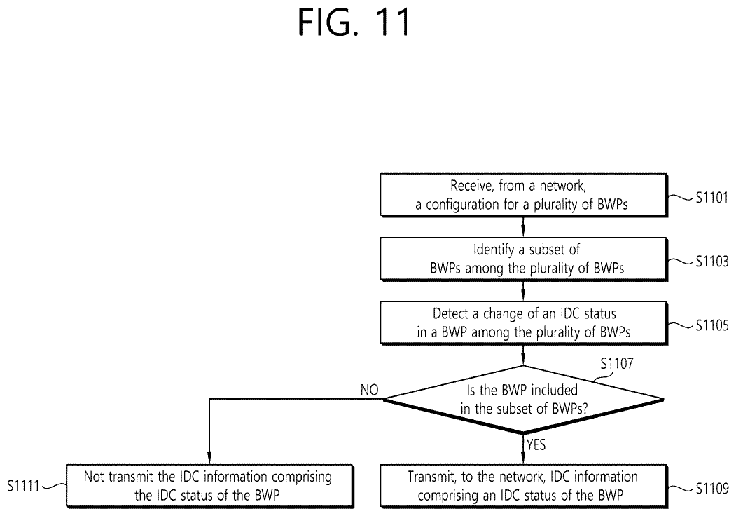

FIG. 11 shows an example of a method performed by a UE according to an embodiment of the present disclosure. The method may also be performed by a wireless device.

Referring to FIG. 11, in step S1101, the UE may receive, from a network, a configuration for a plurality of BWPs.

In step S1103, the UE may identify a subset of BWPs among the plurality of BWPs.

In step S1105, the UE may detect a change of an IDC status in a BWP among the plurality of BWPs.

In step S1107, the UE may determine whether the BWP in which a change of an IDC status is detected is included in the subset of BWPs.

If the BWP is included in the subset of BWPs, in step S1109, the UE may transmit, to the network, IDC information comprising an IDC status of the BWP.

If the BWP is not included in the subset of BWPs, in step S1111, the UE may not transmit the IDC information comprising the IDC status of the BWP, to the network.

According to various embodiments, the IDC status may comprise at least one of: a first status in which IDC problem is detected or exists; or a second status in which IDC problem is resolved or does not exist.

According to various embodiments, the IDC information may further comprise IDC statuses of one or more other BWPs among the plurality of BWPs.

According to various embodiments, the one or more other BWPs may be included in the subset of BWPs.

According to various embodiments, the one or more other BWPs may comprise at least one of: a BWP included in the subset of BWPs; or a BWP not included in the subset of BWPs.

According to various embodiments, the UE may receive, from the network, a configuration for the subset of BWPs.

According to various embodiments, the UE may receive, from the network, an IDC configuration comprising an indication to transmit the IDC information to the network. The IDC configuration may further comprise the configuration for the subset of BWPs.

According to various embodiments, the subset of BWPs may comprise one or more active BWPs and does not comprise one or more non-active BWPs.

According to various embodiments, the subset of BWPs may comprise all of the plurality of BWPs.

According to various embodiments, the subset of BWPs may comprise one or more active BWPs and one or more non-active BWPs.

According to various embodiments, based on the BWP being not included in the subset of BWPs, the UE may transmit, to the network, the IDC information comprising the IDC status of the BWP after performing a BWP switching to the BWP.

According to various embodiments, the UE may configure a subset of BWPs among configured BWPs. The UE may transmit an IDC indication to network if a change of IDC status in the BWP of the BWP subset list is detected. The IDC indication may include the IDC status of the BWP(s) in the BWP subset and the IDC status of the BWP(s) not in the BWP subset among the configured BWPs. The UE may transmit an IDC indication to network upon BWP switching. The transmission of the IDC indication upon BWP switching may be triggered only if the IDC status of the BWP not in the BWP subset has changed since it was reported.

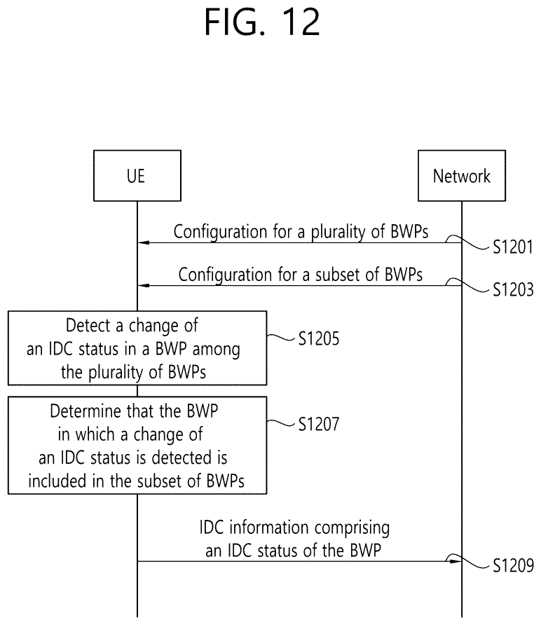

FIG. 12 shows an example of a signal flow between UE and network node according to an embodiment of the present disclosure. The network node may comprise a base station (BS).

Referring to FIG. 12, in step S1201, the network node may transmit, to a UE, a configuration for a plurality of BWPs.

In step S1203, the network node may transmit, to the UE, a configuration for a subset of BWPs among the plurality of BWPs.

In step S1205, the UE may detect a change of an IDC status in the BWP among the plurality of BWPs.

In step S1207, the UE may determine that the BWP in which IDC status change is detected is included in the subset of BWPs.

In step S1209, the UE may transmit, to the network node, the IDC information comprising the IDC status of the BWP, based on the BWP being included in the subset of BWPs. The network node may receive, from the UE, the IDC information comprising the IDC status of the BWP.

In some implementation of the present disclosure, if UE detects an IDC problem, UE may IDC indication message comprising IDC status to network, where the IDC indication message includes both IDC status of active BWP and possibly IDC status of non-active BWPs. Then if UE detects that concerned IDC status changes, UE may report a new IDC status to network.

The IDC indication message may include frequency information related to detected IDC problem. The frequency information may include a list of frequencies that are affected by the IDC problem. The frequency information may include a list of frequency/band combinations that are affected by inter-modulation or harmonics of multi-carrier UL operations (e.g., CA/DC). For each frequency information, interference direction may be included to indicate whether the UE is a victim or an aggressor for the concerned frequency, and the system/device type may be included to indicate the affected system type (such as GNSS/WLAN/BT, etc).

The IDC indication message may include TDM assistance information. The TDM assistance information may include preferred DRX pattern information. The TDM assistance information may include preferred time pattern information to coordinate between in-devices.

UE may be configured with condition(s) to determine which BWP among configured BWPs can be used to trigger IDC indication. For example, one or more of the following conditions can be configured:
(1) Condition 1 (C1): Only active BWP(s)
   IDC status change of active BWP can trigger IDC indication message. IDC status change of any non-active BWP does not trigger IDC indication message.
(2) Condition 2 (C2): All configured BWP (active BWP(s) and non-active BWP(s))
   IDC status change of active BWP or any non-active BWP can trigger IDC indication message.
(3) Condition 3 (C3): Active BWP(s) and a subset of non-active BWPs
   IDC status change of active BWP or any non-active BWP among the subset of non-active BWPs can trigger IDC indication message, IDC status change of non-active BWP outside the subset of non-active BWPs does not trigger IDC indication message.

UE may be (pre) configured with one or more conditions. For example, UE may be specified to apply a certain condition, either C1 or C2 or C3. UE may be specified to select a certain condition among conditions based on cases. For example, UE may apply C2 for PCell frequency and C1 or C3 for other serving frequencies.

Network may configure UE with one or more conditions to apply. For example, network may configure UE with a certain condition to apply, either C1 or C2 or C3. For example, network may configure UE with multiple conditions via RRC configuration and activate one of the configured conditions via DCI/MAC CE signaling to apply. Network may configure UE with different conditions for different frequencies. For example, network may configure UE with C2 for PCell frequency but the network configures UE with C1 or C3 for other serving frequencies.

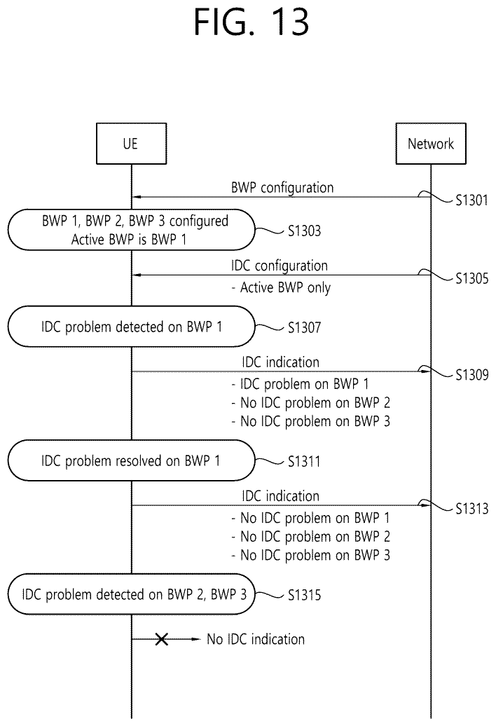

FIG. 13 shows an example of a signal flow for transmitting IDC indication message based on condition 1 according to an embodiment of the present disclosure.

Referring to FIG. 13, in step S1301, the UE may receive, from a network, BWP configurations for BWP1, BWP2 and BWP3.

In step S1303, the UE may determine that active BWP is BWP1, among the configured BWP1, BWP2 and BWP3.

In step S1305, the UE may receive an IDC configuration from the network. The IDC configuration may indicate condition 1-“active BWP only”.

In step S1307, the UE may detect IDC problem on BWP1, which is active BWP.

In step S1309, the UE may transmit, to the network, IDC indication message comprising

IDC statuses of the BWP1, BWP2 and BWP3-that is, the IDC indication message may indicate i) IDC problem on BWP1, ii) no IDC problem on BWP2, and iii) no IDC problem on BWP3.

In step S1311, the UE may detect that IDC problem is resolved on BWP1.

In step S1313, the UE may transmit, to the network, IDC indication message comprising IDC statuses of the BWP1, BWP2 and BWP3-that is, the IDC indication message may indicate i) no IDC problem on BWP1, ii) no IDC problem on BWP2, and iii) no IDC problem on BWP3.

In step S1315, the UE may detect IDC problem detected on BWP2 and/or BWP3. Since BWP2 and BWP3 do not meet the C1 (i.e., BWP2 and BWP3 are not active BWP), the UE does not transmit IDC indication message.

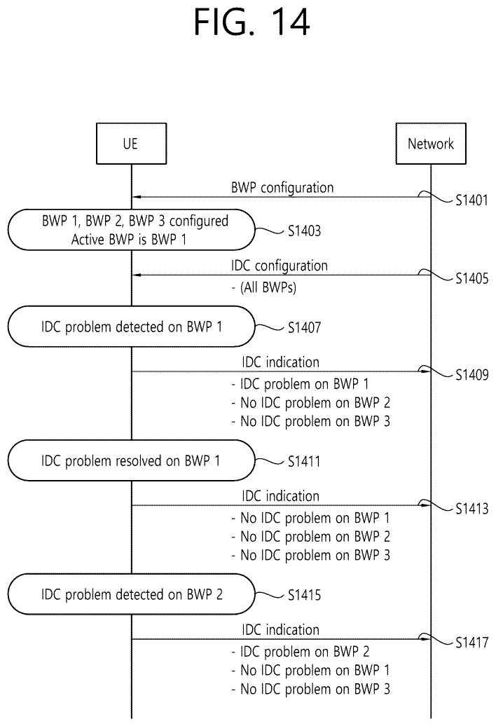

FIG. 14 shows an example of a signal flow for transmitting IDC indication message based on condition 2 according to an embodiment of the present disclosure.

Referring to FIG. 14, in step S1401, the UE may receive, from a network, BWP configurations for BWP1, BWP2 and BWP3.

In step S1403, the UE may determine that active BWP is BWP1, among the configured BWP1, BWP2 and BWP3.

In step S1405, the UE may receive an IDC configuration from the network. The IDC configuration may indicate condition 2-“all BWPs”

In step S1407, the UE may detect IDC problem on BWP1, which is active BWP.

In step S1409, the UE may transmit, to the network, IDC indication message comprising IDC statuses of the BWP1, BWP2 and BWP3-that is, the IDC indication message may indicate i) IDC problem on BWP1, ii) no IDC problem on BWP2, and iii) no IDC problem on BWP3.

In step S1411, the UE may detect that IDC problem is resolved on BWP1.

In step S1413, the UE may transmit, to the network, IDC indication message comprising IDC statuses of the BWP1, BWP2 and BWP3-that is, the IDC indication message may indicate i) no IDC problem on BWP1, ii) no IDC problem on BWP2, and iii) no IDC problem on BWP3.

In step S1415, the UE may detect IDC problem detected on BWP2.

In step S1417, since BWP2 meets the C2 (i.e., BWP belongs to all BWPs), the UE may transmit IDC indication message comprising IDC statuses of the BWP1, BWP2 and BWP3-that is, the IDC indication message may indicate i) no IDC problem on BWP1, ii) IDC problem on BWP2, and iii) no IDC problem on BWP3.

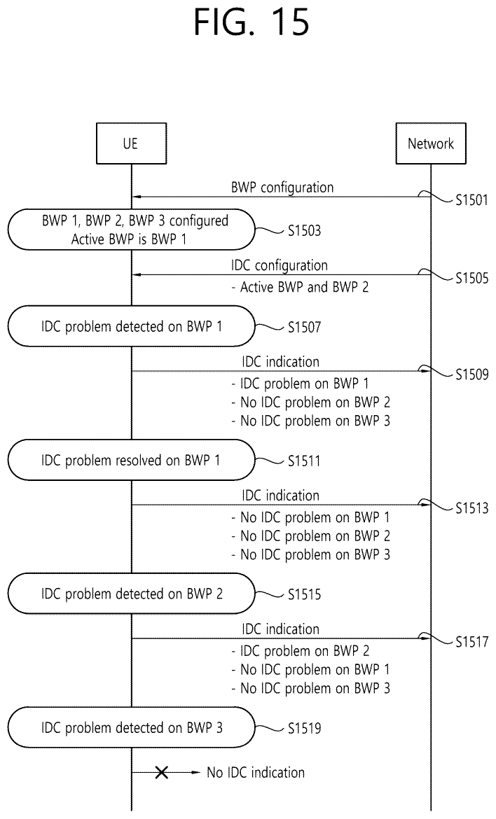

FIG. 15 shows an example of a signal flow for transmitting IDC indication message based on condition 3 according to an embodiment of the present disclosure.

Referring to FIG. 15, in step S1501, the UE may receive, from a network, BWP configurations for BWP1, BWP2 and BWP3.

In step S1503, the UE may determine that active BWP is BWP1, among the configured BWP1, BWP2 and BWP3.

In step S1505, the UE may receive an IDC configuration from the network. The IDC configuration may indicate condition 3-“active BWP and BWP2”.

In step S1507, the UE may detect IDC problem on BWP1, which is active BWP.

In step S1509, the UE may transmit, to the network, IDC indication message comprising IDC statuses of the BWP1, BWP2 and BWP3-that is, the IDC indication message may indicate i) IDC problem on BWP1, ii) no IDC problem on BWP2, and iii) no IDC problem on BWP3.

In step S1511, the UE may detect that IDC problem is resolved on BWP1.

In step S1513, the UE may transmit, to the network, IDC indication message comprising IDC statuses of the BWP1, BWP2 and BWP3-that is, the IDC indication message may indicate i) no IDC problem on BWP1, ii) no IDC problem on BWP2, and iii) no IDC problem on BWP3.

In step S1515, the UE may detect IDC problem detected on BWP2.

In step S1517, since BWP2 meets the C2 (i.e., BWP belongs to all BWPs), the UE may transmit IDC indication message comprising IDC statuses of the BWP1, BWP2 and BWP3-that is, the IDC indication message may indicate i) no IDC problem on BWP1, ii) IDC problem on BWP2, and iii) no IDC problem on BWP3.

In step S1519, the UE may detect IDC problem detected on BWP3. Since BWP3 does not meet the C3 (i.e., BWP3 is neither active BWP nor BWP2), the UE does not transmit IDC indication message.

In some implementations, UE may trigger IDC indication upon BWP switching. For example, UE may be configured to trigger IDC indication upon change of IDC status on active BWP such that IDC indication is triggered from the change of IDC status of only active BWP, not from non-active BWPs. Whilst the active-BWP based triggering condition can reduce the number of IDC triggerings, IDC status of non-active BWPs may not be fully known to network. For such UE, triggering of IDC indication upon BWP switching may be beneficial. If BWP switching happens to the UE, UE may send IDC indication to inform or update network of IDC status of non-active BWP. It is desirable that the IDC indication is sent after BWP switching is completed.

Triggering of IDC indication upon BWP switching may be restricted. As an example of the restriction, UE may send IDC indication only upon BWP switching to a BWP for which UE detects a IDC problem/change of IDC status. If BWP switching happens to a BWP for which UE does not detect a IDC problem/change of IDC status, UE does not send a IDC indication. This restriction can reduce the unnecessary triggering of IDC indication upon BWP switching.

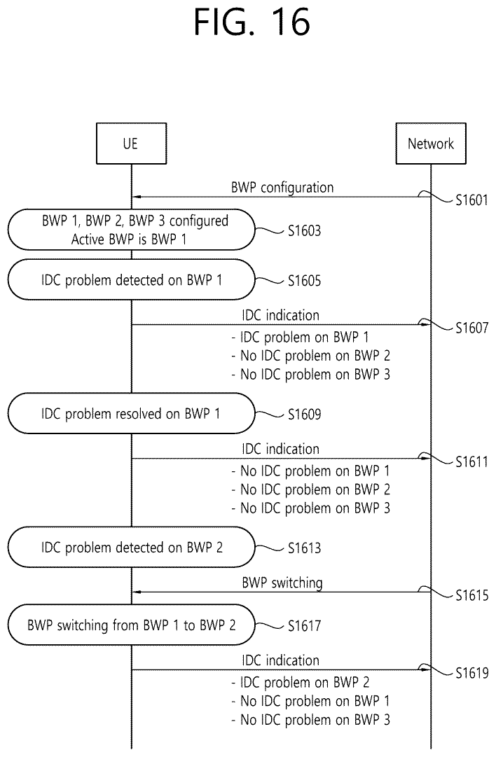

FIG. 16 shows an example of a signal flow for transmitting IDC indication message based on BWP switching according to an embodiment of the present disclosure.

Referring to FIG. 16, in step S1601, the UE may receive, from a network, BWP configurations for BWP1, BWP2 and BWP3.

In step S1603, the UE may determine that active BWP is BWP1, among the configured BWP1, BWP2 and BWP3. It is assumed that condition 1-“active BWP only” is applied.

In step S1605, the UE may detect IDC problem on BWP1, which is active BWP.

In step S1607, the UE may transmit, to the network, IDC indication message comprising IDC statuses of the BWP1, BWP2 and BWP3-that is, the IDC indication message may indicate i) IDC problem on BWP1, ii) no IDC problem on BWP2, and iii) no IDC problem on BWP3.

In step S1609, the UE may detect that IDC problem is resolved on BWP1.

In step S1611, the UE may transmit, to the network, IDC indication message comprising IDC statuses of the BWP1, BWP2 and BWP3-that is, the IDC indication message may indicate i) no IDC problem on BWP1, ii) no IDC problem on BWP2, and iii) no IDC problem on BWP3.

In step S1613, the UE may detect IDC problem detected on BWP2.

In step S1615, the UE may receive, from the network, a command for BWP switching to BWP2, via DCI or RRC signalling.

In step S1617, the UE may perform BWP switching from BWP1 to BWP2.

In step S1619, since BWP2 does not meet the C1 (i.e., BWP2 is not active BWP) but the UE has performed BWP switching to BWP2, the UE may transmit, to the network, IDC indication message comprising IDC statuses of the BWP1, BWP2 and BWP3-that is, the IDC indication message may indicate i) no IDC problem on BWP1, ii) IDC problem on BWP2, and iii) no IDC problem on BWP3.

Furthermore, the method in perspective of the UE described in the present disclosure (e.g., in FIG. 11) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

Furthermore, the method in perspective of the UE described in the present disclosure (e.g., in FIG. 11) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

Furthermore, the method in perspective of the UE described in the present disclosure (e.g., in FIG. 11) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network, a configuration for a plurality of bandwidth parts (BWPs); identifying a subset of BWPs among the plurality of BWPs; detecting a change of an IDC status in a BWP among the plurality of BWPs; determining whether the BWP in which a change of an IDC status is detected is included in the subset of BWPs; and transmitting, to the network, IDC information comprising an IDC status of the BWP, based on the BWP being included in the subset of BWPs.

Furthermore, the method in perspective of a network node described in the present disclosure (e.g., in FIG. 12) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations. The operations comprise: transmitting, to a user equipment (UE), a configuration for a plurality of bandwidth parts (BWPs); transmitting, to the UE, a configuration for a subset of BWPs among the plurality of BWPs; and receiving, from the UE, IDC information comprising an IDC status of a BWP in which IDC status change is detected based on the BWP being included in the subset of BWPs, wherein the UE is further configured to: detect a change of an IDC status in the BWP among the plurality of BWPs; determine whether the BWP in which IDC status change is detected is included in the subset of BWPs; and transmit, to the network, the IDC information comprising the IDC status of the BWP, based on the BWP being included in the subset of BWPs. The present disclosure may have various advantageous effects.

For example, the UE may indicate to the network IDC statuses of configured BWPs properly while preventing too frequent triggering of IDC indications.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving, from a network, a configuration for a plurality of bandwidth parts (BWPs);
identifying a subset of BWPs among the plurality of BWPs;
detecting a change of an IDC status in a BWP among the plurality of BWPs;
determining whether the BWP in which a change of an IDC status is detected is included in the subset of BWPs; and
transmitting, to the network, IDC information comprising an IDC status of the BWP, based on the BWP being included in the subset of BWPs.

2. The method of claim 1, wherein the IDC status comprises at least one of:
a first status in which IDC problem is detected or exists; or
a second status in which IDC problem is resolved or does not exist.

3. The method of claim 1, wherein the IDC information further comprises IDC statuses of one or more other BWPs among the plurality of BWPs.

4. The method of claim 3, wherein the one or more other BWPs are included in the subset of BWPs.

5. The method of claim 3, wherein the one or more other BWPs comprise at least one of:
a BWP included in the subset of BWPs; or
a BWP not included in the subset of BWPs.

6. The method of claim 1, further comprising receiving, from the network, a configuration for the subset of BWPs.

7. The method of claim 6, further comprising receiving, from the network, an IDC configuration comprising an indication to transmit the IDC information to the network,
wherein the IDC configuration further comprises the configuration for the subset of BWPs.

8. The method of claim 1, wherein the subset of BWPs comprises one or more active BWPs and does not comprise one or more non-active BWPs.

9. The method of claim 1, wherein the subset of BWPs comprises all of the plurality of BWPs.

10. The method of claim 1, wherein the subset of BWPs comprises one or more active BWPs and one or more non-active BWPs.

11. The method of claim 1, wherein, based on the BWP being not included in the subset of BWPs, the method further comprises not transmitting the IDC information comprising the IDC status of the BWP in which IDC status change is detected.

12. The method of claim 1, further comprising based on the BWP being not included in the subset of BWPs, transmitting, to the network, the IDC information comprising the IDC status of the BWP after performing a BWP switching to the BWP.

13. The method of claim 1, wherein the method is performed by a user equipment (UE) in communication with at least one of a mobile device, a network, or autonomous vehicles.

14. A user equipment (UE) configured to operate in a wireless communication system, the UE comprising:
at least one transceiver;
at least one processor; and
at least one memory operatively coupled to the at least one processor and storing instructions that, based on being executed by the at least one processor, perform operations comprising:
receiving, from a network, a configuration for a plurality of bandwidth parts (BWPs);
identifying a subset of BWPs among the plurality of BWPs;
detecting a change of an IDC status in a BWP among the plurality of BWPs;
determining whether the BWP in which a change of an IDC status is detected is included in the subset of BWPs; and
transmitting, to the network, IDC information comprising an IDC status of the BWP, based on the BWP being included in the subset of BWPs.

15. (canceled)

16. A network node configured to operate in a wireless communication system, the network node comprising:
at least one transceiver;
at least one processor; and
at least one memory operatively coupled to the at least one processor and storing instructions that, based on being executed by the at least one processor, perform operations comprising:
transmitting, to a user equipment (UE), a configuration for a plurality of bandwidth parts (BWPs);
transmitting, to the UE, a configuration for a subset of BWPs among the plurality of BWPs; and
receiving, from the UE, IDC information comprising an IDC status of a BWP in which IDC status change is detected based on the BWP being included in the subset of BWPs,
wherein the UE is further configured to:
detect a change of an IDC status in the BWP among the plurality of BWPs;
determine whether the BWP in which IDC status change is detected is included in the subset of BWPs; and
transmit, to the network, the IDC information comprising the IDC status of the BWP, based on the BWP being included in the subset of BWPs.

17-20. (canceled)
